(19) United States
(12) Patent Application Publication
(10) Pub. No.: US 2010/0321197 A1
(43) Pub. Date: Dec. 23, 2010

(54) PASSWORD INPUT DEVICE

(75) Inventors: Kwok Fong Wong, Hong Kong (HK); Pui Yi Ching, Hong Kong (HK)

Correspondence Address: BYIP, LTD., P.O. BOX 1484, GENERAL POST OFFICE, HONG KONG, HK

(73) Assignee: Kwok Fong WONG

(21) Appl. No.: 12/607,065

(22) Filed: Oct. 28, 2009

(30) Foreign Application Priority Data
Jun. 18, 2009 (HK) 09105479.0

(51) Int. Cl. G08B 5/00; G06F 7/04

(52) U.S. Cl. 340/691.3; 340/5.83; 340/825.36

(57) ABSTRACT

A password input device for inputting a password to an external device includes a fingerprint scanning unit for scanning and acquiring a fingerprint of a user; a storage unit for storing an association between a predetermined fingerprint and a predetermined password; a password matching unit connected with the fingerprint scanning unit and the storage unit, and configured for searching through the storage unit for a password associated with the fingerprint acquired by the fingerprint scanning unit and after finding the password transmitting the found password to the external device; a password receiving unit connected with the fingerprint scanning unit and the storage unit, and configured for receiving a password input by a user, and storing an association between the fingerprint acquired by the fingerprint scanning unit and the password input by the user in the storage unit; and a security warning unit connected to the password receiving unit and configured for analyzing the password input by the user and indicating the security level of the password.

### CROSS-REFERENCE TO RELATED APPLICATIONS

This application claims the priority of Hong Kong Patent Application No. 09105479.0, filed on Jun. 18, 2009; the contents of which is hereby incorporated by reference.

### FIELD OF THE PATENT APPLICATION

The present invention generally relates to authentication technologies and more particularly to a device for inputting passwords to an information processing system.

### BACKGROUND

For most information processing systems that require user access control for security purposes, such as Bank ATMs (Automated Teller Machines), home or office computers, mobile phones, PDAs (Personal Digital Assistants) and so on, a user needs to input a password to access the system. The length of a chosen password is proportional to the level of security associated with the password and the difficulty for a hacker to crack the password. From a perspective of effective protection, a relatively long password is desired. From a user experience perspective, however, it is hard or at least inconvenient for a user to remember a long password for a long period of time. In addition, the fact that different systems that a user uses may have different passwords makes it even more difficult and less comfortable for the user to remember all the relatively long passwords.

### SUMMARY

The present patent application is directed to a password input device for inputting a password to an external device. In one aspect, the password input device includes a fingerprint scanning unit for scanning and acquiring a fingerprint of a user; a storage unit for storing an association between a predetermined fingerprint and a predetermined password; a password matching unit connected with the fingerprint scanning unit and the storage unit, the password matching unit being configured for searching through the storage unit for a password associated with the fingerprint acquired by the fingerprint scanning unit and after finding the password transmitting the found password to the external device; a password receiving unit connected with the fingerprint scanning unit and the storage unit, the password receiving unit being configured for receiving a password input by a user, and storing an association between the fingerprint acquired by the fingerprint scanning unit and the password input by the user in the storage unit; and a security warning unit connected to the password receiving unit and configured for analyzing the password input by the user and indicating the security level of the password.

The security warning unit may include a plurality of light-emitting diodes and a security assessment module connected to the light-emitting diodes. The security assessment module is configured for assessing the security level of the password input by the user and controlling the status of the light-emitting diodes according to the assessment.

The fingerprint scanning unit may include a fingerprint sensor on a flexible printed circuit board (FPCB) and a light-emitting diode for indicating the status of the fingerprint scanning unit.

The password input device may further include an interface unit. The password matching unit is configured to transmit the found password to the external device through the interface unit. The password receiving unit is configured to receive the password input by the user from the external device through the interface unit.

In another aspect, the present patent application provides a password input device for inputting a password to an external device. The password input device includes a fingerprint scanning unit for scanning and acquiring a fingerprint of a user; a storage unit for storing an association between a predetermined fingerprint and a predetermined password; and a password matching unit connected with the fingerprint scanning unit and the storage unit. The password matching unit is configured for searching through the storage unit for a password associated with the fingerprint acquired by the fingerprint scanning unit and after finding the password transmitting the found password to the external device. The fingerprint scanning unit includes a fingerprint sensor on a flexible printed circuit board (FPCB) and a light-emitting diode for indicating the status of the fingerprint scanning unit.

In yet another aspect, the present patent application provides a password input system. The password input system includes an information processing device including a user input interface; a fingerprint scanning unit for scanning and acquiring a fingerprint of a user; a storage unit for storing an association between a predetermined fingerprint and a predetermined password; a password matching unit connected with the information processing device, the fingerprint scanning unit and the storage unit, the password matching unit being configured for searching through the storage unit for a password associated with the fingerprint acquired by the fingerprint scanning unit and after finding the password transmitting the found password to the information processing device; a password receiving unit connected with the information processing device, the fingerprint scanning unit and the storage unit, the password receiving unit being configured for receiving a password input by a user through the user input interface of the information processing system and storing an association between the fingerprint acquired by the fingerprint scanning unit and the password input by the user in the storage unit; and a security warning unit connected to the password receiving unit and configured for analyzing the password input by the user and indicating the security level of the password.

### BRIEF DESCRIPTION OF THE DRAWINGS

FIG. 1 is a block diagram of a password input device according to an embodiment of the present patent application.

FIG. 2 is a block diagram of a password input device according to another embodiment of the present patent application.

FIG. 3 is a block diagram of a password input device according to yet another embodiment of the present patent application.

FIG. 4 is a block diagram of a password input device according to still another embodiment of the present patent application.

FIG. 5 is a block diagram of a password input device according to still another embodiment of the present patent application.

### DETAILED DESCRIPTION

Reference will now be made in detail to a preferred embodiment of the password input device disclosed in the present patent application, examples of which are also provided in the following description. Exemplary embodiments of the password input device disclosed in the present patent application are described in detail, although it will be apparent to those skilled in the relevant art that some features that are not particularly important to an understanding of the password input device may not be shown for the sake of clarity.

Furthermore, it should be understood that the password input device disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

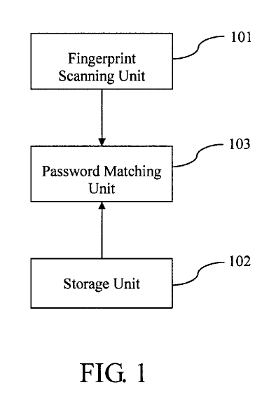

FIG. 1 is a block diagram of a password input device according to an embodiment of the present patent application. Referring to FIG. 1, the password input device includes a fingerprint scanning unit 101, a storage unit 102, and a password matching unit 103. The fingerprint scanning unit 101 is connected with the password matching unit 103 and configured for acquiring an image of a user's fingerprint. The storage unit 102 is connected with the password matching unit 103 and configured for storing the user's fingerprint image and an ASCII (American Standard Code for Information Interchange) password associated with the fingerprint image. The password matching unit 103 is configured to search for an ASCII password associated with the fingerprint image through the storage unit 102 and output the ASCII password. It is noted the ASCII passwords stored in the storage unit 102 can be super long.

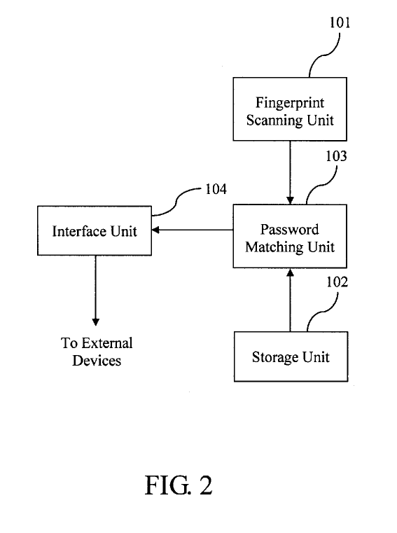

FIG. 2 is a block diagram of a password input device according to another embodiment of the present patent application. Referring to FIG. 2, the password input device in this embodiment is the same as the one depicted in FIG. 1, except that the password input device in this embodiment further includes an interface unit 104. The interface unit 104 is connected to the password matching unit 103 and configured to transmit the ASCII password output by the password matching unit 103 to an external device that is connected to the interface unit 104 and needs a password input. The external device may be any system that requires user access control for security purposes, such as a Bank ATM (Automated Teller Machine), a home or office computer, a mobile phone, a PDA (Personal Digital Assistant) and so on. In this embodiment, the interface unit 104 is a Universal Serial Bus (USB) interface, a Serial Peripheral Interface (SPI) interface, or an integrated USB and SPI interface.

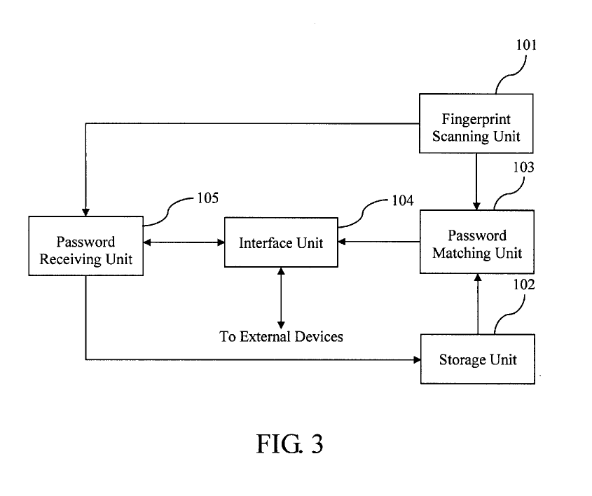

FIG. 3 is a block diagram of a password input device according to yet another embodiment of the present patent application. Referring to FIG. 3, comparing to the password input device shown in FIG. 2, the password input device in this embodiment further includes a password receiving unit 105. The password receiving unit 105 is connected to the fingerprint scanning unit 101 and the storage unit 102, and is configured to receive a fingerprint image acquired by the fingerprint scanning unit 101 and an ASCII password input by a user, and to store an association between the fingerprint image and the ASCII password in the storage unit 102. The password receiving unit 105 is connected with the interface unit 104 and configured to receive the ASCII password from the external device through the interface unit 104. The external device, such as a computer, may have a user input interface for the user to input the ASCII password. In this embodiment, the user may copy a super long password from another application running in the external device and paste the super long password into the user input interface so that the password receiving unit 105 can store an association between the password and a scanned fingerprint image of the user in the storage unit 102. For example, if the external device is a computer, the super long password may be a URL (Uniform Resource Locator) address copied from the address bar of the application Microsoft Internet Explorer running on that computer: “http://login.live.com/login.srf?wa=wsignin1.0&rpsnv=10&ct=1243330084&rver=5.5.4177.0&wp=MBI&wlcxt=title&wreply=http:%2F%2Fskydrive.live.com%2F welcome.aspx&1c=2052&id=250206”.

After the password receiving unit 105 stores the association between the user's fingerprint image and the ASCII password in the storage unit 102, when the same fingerprint is scanned again, the password matching unit 103 is configured to search for and retrieve the ASCII password associated with the fingerprint image from the storage unit 102.

In this embodiment, the user can associate the fingerprint image of each one of her/his fingers with a unique ASCII password. By this means, each finger corresponds to a unique ASCII password, which can be used for a unique purpose, such as logging into a particular system, accessing a particular website, and so on.

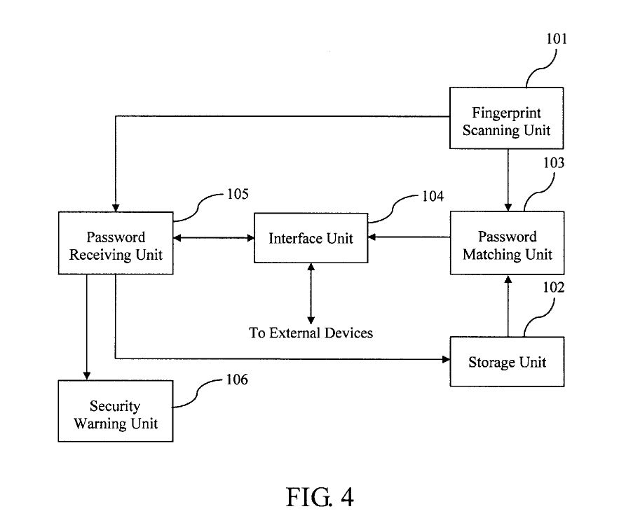

FIG. 4 is a block diagram of a password input device according to still another embodiment of the present patent application. Referring to FIG. 4, comparing to the password input device depicted in FIG. 3, the password input device in this embodiment further includes a security warning unit 106. The security warning unit 106 is connected to the password receiving unit 105 and configured for indicating the security level of a received ASCII password according to the length thereof.

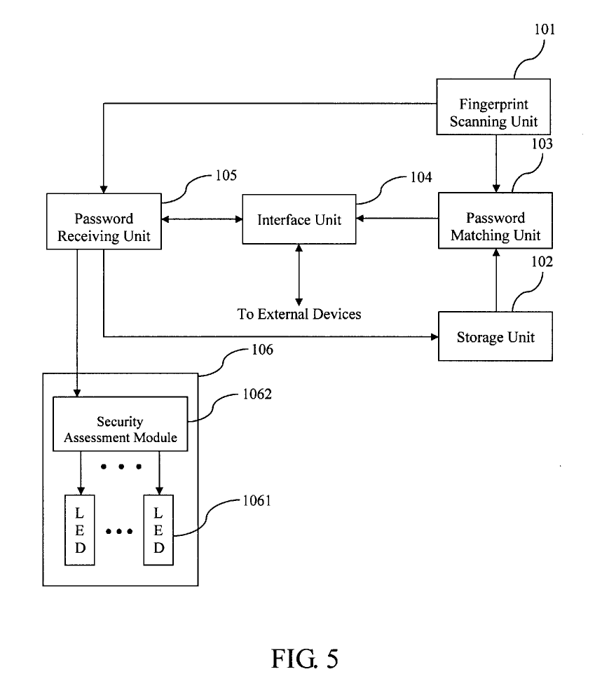

FIG. 5 is a block diagram of a password input device according to still another embodiment of the present patent application. Referring to FIG. 5, in this embodiment, the security warning unit 106 includes a plurality of LEDs (light-emitting diodes) 1061 and a security assessment module 1062. The security assessment module 1062 is connected with the LEDs 1061 and configured for assessing the security level of an ASCII password that the security warning unit 106 receives, and controlling the status of the LEDs 1061 according to the security level so as to indicate the security level to a user. Such assessment may, for example, be based on the length of the ASCII password. The LEDs 1061 in this embodiment may have different colors. According to the assessed security level of the ASCII password, the security assessment module 1062 may, for example, selectively turn on or off the LEDs 1061 and/or selectively control the blinking rate of the LEDs 1061.

In this embodiment, as an example, if the received ASCII password is less than 6 letters long, a red LED may be turned on for 3 seconds and to be blinking for 3 times in every second; if the received ASCII password is greater than 6 letters long and less than 10 letters long, a light green LED may be turned on for 3 seconds and to be blinking for 3 times in every second; if the received ASCII password is greater than 10 letters long and less than 50 letters long, a green LED may be turned on for 3 seconds and to be blinking once in every second; if the received ASCII password is greater than 50 letters long, a dark green LED may be turned on for 3 seconds.

In the above embodiments, the fingerprint scanning unit 101 includes a fingerprint sensor on a Flexible Printed Circuit Board (FPCB) or any type of fingerprint sensor that is currently available, and at least a LED for indicating the status of the fingerprint scanning unit 101. For example, the LED may be turned on to indicate that the fingerprint scanning is in process. The password input device in the above embodiments can be a standalone device, or be integrated with an external device that needs password input.

While the present patent application has been shown and described with particular references to a number of embodiments thereof, it should be noted that various other changes or modifications may be made without departing from the scope of the present invention.

What is claimed is:

1. A password input device for inputting a password to an external device, the password input device comprising:
a fingerprint scanning unit for scanning and acquiring a fingerprint of a user;
a storage unit for storing an association between a predetermined fingerprint and a predetermined password;
a password matching unit connected with the fingerprint scanning unit and the storage unit, the password matching unit being configured for searching through the storage unit for a password associated with the fingerprint acquired by the fingerprint scanning unit and after finding the password transmitting the found password to the external device;
a password receiving unit connected with the fingerprint scanning unit and the storage unit, the password receiving unit being configured for receiving a password input by a user, and storing an association between the fingerprint acquired by the fingerprint scanning unit and the password input by the user in the storage unit; and
a security warning unit connected to the password receiving unit and configured for analyzing the password input by the user and indicating the security level of the password.

2. The password input device of claim 1, wherein the security warning unit comprises a plurality of light-emitting diodes and a security assessment module connected to the light-emitting diodes, the security assessment module being configured for assessing the security level of the password input by the user and controlling the status of the light-emitting diodes according to the assessment.

3. The password input device of claim 2, wherein the security assessment module is configured to assess the security level of the password by the length of the password and control the status of the light-emitting diodes by selectively turning on or off the light-emitting diodes or by selectively controlling the blinking rate of the light-emitting diodes.

4. The password input device of claim 2, wherein the light-emitting diodes are of different colors.

5. The password input device of claim 1, wherein the fingerprint scanning unit comprises a fingerprint sensor on a flexible printed circuit board (FPCB) and a light-emitting diode for indicating the status of the fingerprint scanning unit.

6. The password input device of claim 1 further comprising an interface unit, the password matching unit being configured to transmit the found password to the external device through the interface unit, the password receiving unit being configured to receive the password input by the user from the external device through the interface unit.

7. The password input device of claim 6, wherein the interface unit is a Universal Serial Bus (USB) interface, a Serial Peripheral Interface (SPI) interface, or an integrated USB and SPI interface.

8. A password input device for inputting a password to an external device, the password input device comprising:
a fingerprint scanning unit for scanning and acquiring a fingerprint of a user;
a storage unit for storing an association between a predetermined fingerprint and a predetermined password; and
a password matching unit connected with the fingerprint scanning unit and the storage unit, the password matching unit being configured for searching through the storage unit for a password associated with the fingerprint acquired by the fingerprint scanning unit and after finding the password transmitting the found password to the external device; wherein:
the fingerprint scanning unit comprises a fingerprint sensor on a flexible printed circuit board (FPCB) and a light-emitting diode for indicating the status of the fingerprint scanning unit.

9. The password input device of claim 8, further comprising:
a password receiving unit connected with the fingerprint scanning unit and the storage unit, the password receiving unit being configured for receiving a password input by a user, and storing an association between the fingerprint acquired by the fingerprint scanning unit and the password input by the user in the storage unit;
a security warning unit connected to the password receiving unit and configured for analyzing the password input by the user and indicating the security level of the password; and
an interface unit, the password matching unit being configured to transmit the found password to the external device through the interface unit, the password receiving unit being configured to receive the password input by the user from the external device through the interface unit.

10. The password input device of claim 9, wherein the security warning unit comprises a plurality of light-emitting diodes and a security assessment module connected to the light-emitting diodes, the security assessment module being configured for assessing the security level of the password input by the user and controlling the status of the light-emitting diodes according to the assessment.

11. The password input device of claim 10, wherein the security assessment module is configured to assess the security level of the password by the length of the password and control the status of the light-emitting diodes by selectively turning on or off the light-emitting diodes or by selectively controlling the blinking rate of the light-emitting diodes.

12. The password input device of claim 10, wherein the light-emitting diodes are of different colors.

13. The password input device of claim 9, wherein the interface unit is a Universal Serial Bus (USB) interface, a Serial Peripheral Interface (SPI) interface, or an integrated USB and SPI interface.

14. A password input system comprising:
an information processing device comprising a user input interface;
a fingerprint scanning unit for scanning and acquiring a fingerprint of a user;
a storage unit for storing an association between a predetermined fingerprint and a predetermined password;
a password matching unit connected with the information processing device, the fingerprint scanning unit and the storage unit, the password matching unit being configured for searching through the storage unit for a password associated with the fingerprint acquired by the fingerprint scanning unit and after finding the password transmitting the found password to the information processing device;
a password receiving unit connected with the information processing device, the fingerprint scanning unit and the storage unit, the password receiving unit being configured for receiving a password input by a user through the user input interface of the information processing system and storing an association between the fingerprint acquired by the fingerprint scanning unit and the password input by the user in the storage unit; and
a security warning unit connected to the password receiving unit and configured for analyzing the password input by the user and indicating the security level of the password.

15. The password input device of claim 14, wherein the security warning unit comprises a plurality of light-emitting diodes and a security assessment module connected to the light-emitting diodes, the security assessment module being configured for assessing the security level of the password input by the user and controlling the status of the light-emitting diodes according to the assessment.

16. The password input device of claim 15, wherein the security assessment module is configured to assess the security level of the password by the length of the password and control the status of the light-emitting diodes by selectively turning on or off the light-emitting diodes or by selectively controlling the blinking rate of the light-emitting diodes.

17. The password input device of claim 15, wherein the light-emitting diodes are of different colors.

18. The password input device of claim 14, wherein the fingerprint scanning unit comprises a fingerprint sensor on a flexible printed circuit board (FPCB) and a light-emitting diode for indicating the status of the fingerprint scanning unit.

19. The password input device of claim 14 further comprising an interface unit, the password matching unit being configured to transmit the found password to the information processing device through the interface unit, the password receiving unit being configured to receive the password input by the user from the information processing device through the interface unit.

20. The password input device of claim 19, wherein the interface unit is a Universal Serial Bus (USB) interface, a Serial Peripheral Interface (SPI) interface, or an integrated USB and SPI interface.
